(19) United States
(12) Patent Application Publication
(10) Pub. No.: US 2007/0144072 A1
(43) Pub. Date: Jun. 28, 2007

(54) Window operator

(76) Inventors: Thomas J. Hansel, Rockford, IL (US); Alec W. Lay, Davis Junction, IL (US)

Correspondence Address: Paul J. Nykaza, Esq.;Wallenstein Wagner & Rockey, Ltd., 53rd Floor, 311 South Wacker Drive, Chicago, IL, 60606-6630, US

(21) Appl. No.: 11/316,389

(22) Filed: Dec. 22, 2005

(51) Int. Cl. E05D 15/28

(52) U.S. Cl. 49/246

(57) ABSTRACT

The present invention provides a window operator for a casement window assembly that has secure and moveable linkage of pivoting parts of the operator. The linkage of the moveable operator parts is provided by a rivet having a rivet head with a plurality of fingers or petals extending radially outward of the center of the rivet, and wherein the petals are formed of thickened rivet material. The rivet head is formed in a conical configuration by the force of bending the rivet head with a conical shaped recess in the forming die, thus providing the method of forming the rivet connection in a smooth and progressive force of deforming the rivet head into a domed shape with the thickened petals extending radially outward and downward due to the conical die surface.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates to a window operator; and more specifically, an improved structure for pivotally connecting an arm member of the operator with a rivet, and the method of securing together such parts of the window operator with a rivet and rivet tooling.

### BACKGROUND OF THE INVENTION

Window assemblies are well-known and are marketed in several different forms. In one type of popular window assembly, a casement window is pivotally supported within a window frame. A window operator is connected between the window and the frame, providing structure for allowing pivotal movement of the window relative the frame, thus moving the window assembly between the open and closed configurations.

Window operators may differ in numerous ways, but generally have a housing, a lever or crank handle, and at least one arm structure that serves to connect the device with the portion of the casement window to be opened. Examples of such devices include the window operators shown in U.S. Pat. Nos. 2,635,485; 4,241,541; and, 6,164,156.

One common aspect of such operator assemblies is the requirement for securing together the working parts of the operator, such that the parts fastened together may still move relative one another. For example, the operator typically includes gear(s), and retractable arms that rotate or otherwise move when the operator is used to open and close the window. Therefore, it is important that such parts of the operator be fastened securely in place, and yet be fasted loose enough to permit rotation or movement of the operator parts.

The pivoting components of the operator are typically secured in place with a fastener, such as a bolt, screw, pin or rivet. However, use of such fasteners can be difficult because of the need for secure fastening of the parts, yet allowing relative movement of the parts, as explained above. Free movement of the attached parts of the operator is crucial for smooth window opening and closing. These parts are subject to likely repetitive use, and risk of localized mechanical stress on the parts and linkage. The manner of attaching the moveable parts of the operator must not only be secure to withstand the stresses applied during use, but must also withstand prolonged and repeated use. Therefore, there exists a need for a fastening structure (and method of assembling the operator) that achieves a consistent secure fit of the parts together, yet allows for movement. The present invention achieves this and other objectives with a particular structure and method of rivet attachment of parts.

Rivets used in various different applications may widely vary in structure and method of forming the rivet in the locked or attached configuration. For example, rivets are used for securing buttons and snaps for apparel and toys such as stuffed animals. An example of such a rivet is shown in U.S. Pat. No. 3,840,974, which relates to a rivet for assembly of parts of a stuffed toy. Another rivet structure is shown in U.S. Pat. No. 5,015,136. That patent depicts two different structures of rivets for linking parts together, one method shown in FIGS. 1 and 2, and the second method shown in FIGS. 3 and 4. In FIGS. 3 and 4 of the patent, the rivet has a concave recess in its bottom surface, and the rivet is formed on a flat die surface acting on the concave rivet recess. The resulting rivet structure is described as having sufficient spring back of the material such that the rivet is secured without frictional binding on the parts being secured together. Yet another rivet assembly of parts is shown in U.S. Pat. No. 3,357,084, in which the rivet head is formed into an anvil that has a stepped outer shoulder providing a cavity with a flat inner region. The outer area of the cavity, having the stepped shoulder, makes contact with the rivet head and forms the rivet head to shape. In this manner, the outer regions of the anvil make contact with the rivet head during forming.

Prior art rivet assembly structure, and forming methods, while presumably suitable for use in some products, are not necessarily optimal for the requirements for fastening together parts of a casement window operator. Thus, there exists a need for a reliable and secure rivet structure and method of forming, suitable for use in securing moveable parts of a casement window operator, which assures the proper frictional engagement. This is particularly true for window operator assemblies having differing configurations and thicknesses of parts to be assembled. For example, the thickness and number of gears and arms may vary, as well as the length of the rivet. The present invention seeks to overcome certain of these limitations and other drawbacks of the prior art, and to provide new features not heretofore available.

### SUMMARY OF THE INVENTION

The present invention relates to an operator for a window assembly having a window moveably connected to a window frame, wherein parts of the operator are secured by a rivet having a structure permitting suitable movement of relative parts of the operator.

According to an aspect of the invention, the window operator has a body with a base configured for mounting to the window assembly and a drive member exposed from the body and operably connected to an operator arm. The operator arm is connected to the drive member with at least one mating gear member that has a plurality of teeth arranged for mating with a screw arrangement of the drive member. The gear member is mounted to the base by a rivet that has an upper rivet head with an exposed recess cavity and a terminal portion biased toward the operator arm and being deformed into a generally conical shape by a force applied along a cupped die surface.

According to another aspect of the invention, a rivet fastener for securing a linkage member of a casement window operator is provided, with a rivet body portion having a central axis and a first end formed of material suitable for compressive deformation, and a second end having a rivet head. The rivet head has a central region connected to the rivet body and an outer periphery region formed from a plurality of fingers extending outward of the central portion and with thickened terminal ends residing radially outward of the central axis of the rivet body. The rivet is configured to be secured to the linkage member as the domed rivet head is deformed to a generally domed shape by compressive force applied between said first and second ends of the rivet, and wherein the force applied at the rivet head includes a forming die having a cupped recess.

According to another aspect of the invention, a method for securing a linkage member for a casement window operator is provided. The method includes the steps of providing a rivet having a rivet body with a deformable first end and an opposed end having a rivet head, wherein the rivet head has generally flat outer surface and a central recess with a thickened region residing at a periphery radially outward of the central recess. A linkage assembly is provided, having a first linkage member with a receiving portion configured for insertion of a portion of the rivet body, and a second linkage member having a receiving portion for insertion of a portion of the rivet body. The method includes the step of inserting the rivet body into a receiving area of the first and second linkage members and placing an inner surface of the rivet head in contact with an adjacent surface of either the first or second linkage member. The rivet is compressed between two forming die surfaces, each located at an opposed end of the rivet body, wherein the die surface in contact with the rivet head has a continuous and smooth concave contact surface to form a generally conical shape of the outer region of the rivet head.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a casement window assembly having an operator assembly of the present invention, depicting the window in an open position relative the frame and the operator arm assembly in an extended arrangement;

FIG. 2 is a top plan view of a portion of the operator assembly of the present invention and as is shown in FIG. 1, with the main body portion of the operator assembly shown with a rivet according to the invention used to secure parts of the operator assembly together;

FIG. 3 is an enlarged view of a portion of the operator assembly shown in FIG. 2, showing detail of the rivet securing parts of the operator assembly together;

FIG. 4 is a cross-sectional view of a portion of the operator assembly with a rivet forming die positioned adjacent the rivet, such as the case when beginning the steps of deforming the rivet head to secure the operator assembly parts together according to the present invention;

FIG. 5 is a cross-sectional view of the rivet area of the operator assembly with a rivet-forming die shown in compressive force against the rivet head and thereby deforming the rivet head into a generally conical shape by the force of the cupped recess of the die; and,

FIG. 6 is a cross-sectional view of the rivet area of the operator assembly, depicting the structure of the rivet in final deformed state for securing together parts of the operator assembly such as is shown in FIG. 2, with the outer portion of the rivet head deformed as a dome and the opposite end of the rivet compressed to lock the rivet in position on the operator housing.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

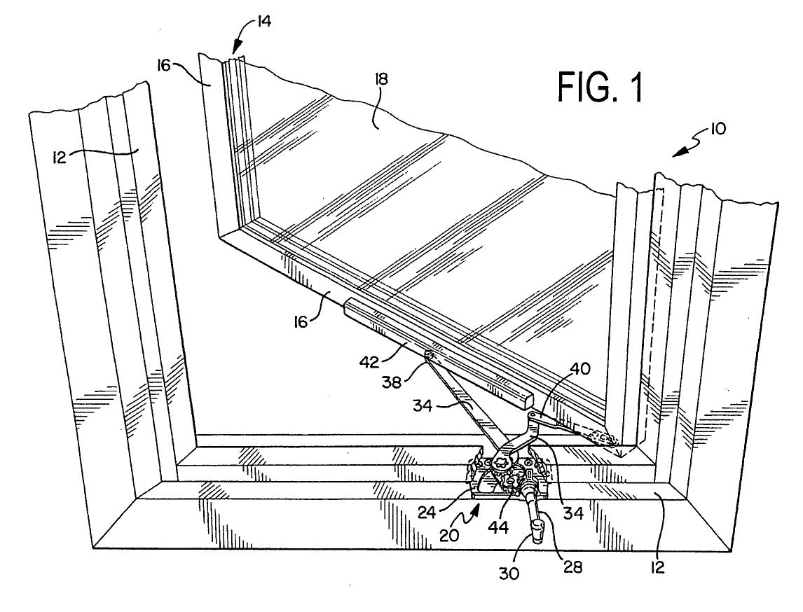

FIG. 1 shows a casement window assembly 10, which includes jamb frame assembly 12, and an inner window assembly 14. The window assembly 14 is formed of a window frame 16 bordering a window pane 18. The inner window assembly 14 and jamb frame assembly 12 are secured by hinged connection (not shown), such that the window 14 is moveable between an open and closed configuration relative the frame assembly 12 by pivotal movement of the inner window assembly 14. FIG. 1 depicts the window assembly 10 with the inner window assembly 14 pivoted into the open configuration relative the frame 12.

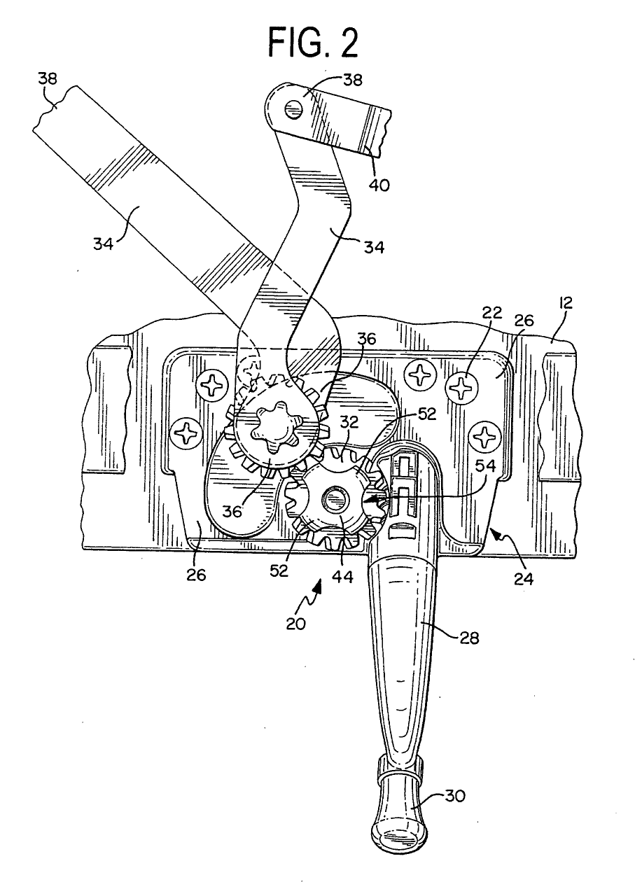

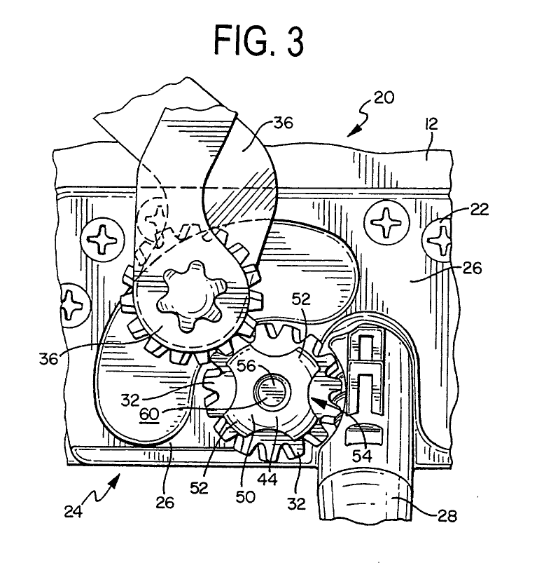

An operator assembly 20 is secured in position between the window frame 12 and the inner window assembly 14 and provides control of the window assembly movable between the open and closed configurations. In the preferred form of the invention, as is compatible with the structure of popular casement window assemblies in the market, the operator assembly 20 is secured into position by fasteners 22 securing the housing 24 of the assembly 20 to the frame assembly 12. In the preferred embodiment shown in the Figures, the fastener 22 passes through the base 26 of the housing 24 of the operator assembly 20, and passes into the frame assembly 12. As the base 26 of the operator assembly 20 is secured to the frame assembly 12, the base 26 provides secure leverage for forcing the window assembly 14 to the open or closed position, which is controlled by a user manipulating the handle 28, preferably at a grasping portion or knob 30. As is commonly provided with such casement assemblies, the handle 28 is mechanically engaged with at least one gear 32 (FIGS. 2, 3), such that rotation of the knob 30 and handle 28 by a user translates to rotation of the at least one gear 32. Typically, this mechanical link between the handle 28 and a gear 32 of a casement window operator assembly 20 includes an additional toothed gear or a screw-type gear (not shown). Whatever the detailed structure employed for transferring movement of the handle into movement of the gear 32, the preferred result is for the gear 32 to rotate about a secure central axis of the gear 32 when the user turns the handle 28.

The operator assembly 20 also includes at least one operator arm 34, having a proximal end portion 36 that is positioned near the gear 32, and a distal end portion 38 that is positioned a distance away from the gear 32. The distal end portion 38 is preferably secured to the window assembly 14, either directly attached to the window assembly 14 or attached by connection of an additional operator arm that serves as a linking arm 40 (FIGS. 1, 2). Attachment of the arm(s) 34 to the inner window assembly 14 preferably allows for movement of the window assembly 14 as the handle 28 and gear 32 are rotated. In the preferred embodiment, this is achieved with the arrangement of the operator arms 34 shown in FIG. 1, wherein a slot receiver assembly 42 links the distal end portion 38 of an operator arm 34 to permit sliding movement between the arm 34 and the frame 16 of the window assembly 14 as the operator arm 34 is angularly re-positioned by the user manipulating the assembly 20 by turning of the handle 28.

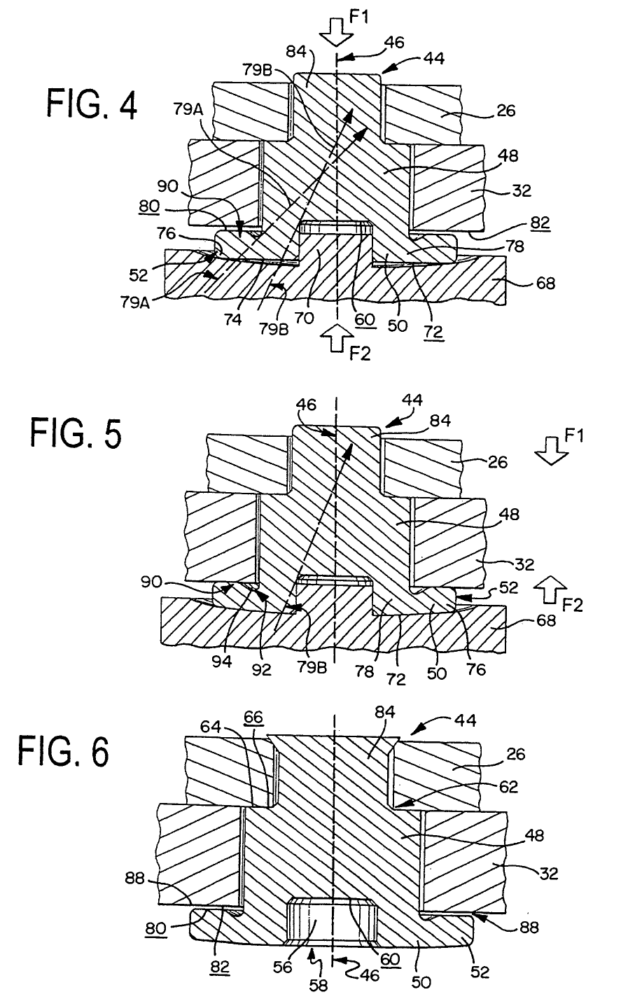

The gear 32 is secured in place by a rivet member 44 centrally located on the gear 32 such that the central axis 46 of the rivet 44 is aligned with the central axis of the gear 32. The rivet 44 has a main body 48 (FIGS. 4-6) residing about the central axis 46, and a rivet head 50 integral with the main body 48 at one end of the central axis 46. The rivet head 50 preferably has an outer peripheral edge that is not round, and instead is formed of outwardly extending fingers 52, such as is shown in FIG. 3. In a preferred embodiment in which a plurality of opposed petals or fingers 52 extend radially outward from the central axis 46, the rivet head 50 has a starfish or a flower-like configuration. Thus, the rivet head 50 has a recessed regions 54 about its periphery, with the finger(s) 52 extending outward and being susceptible to deformation nor displacement by the force of a die surface applied in a direction transverse to the central axis 46 of the rivet 44.

The rivet member 44 preferably has a central recess 56 passing though the rivet head 50 in alignment with the central axis 46. The central recess 56 is dimensioned to provide a passageway 58 (FIG. 6) through at least a portion of the rivet head 50 to a recess surface 60 of the rivet main body 48 in alignment with the central axis 46. The rivet member 44 also preferably includes at least one, and potentially a plurality of, shoulder area(s) along the extent of the main body 48. In the preferred form of the invention, the shoulder area 62 is the result of a stepped profile of the outer area of the main body 48, such as is shown in FIGS. 4-6, providing at least one shoulder abutment 64 for engagement with a surface 66 of a portion of the operator assembly being secured in place by the rivet 44. In the embodiment shown in the Figures (FIG. 6), the engaging surface 66 of the operator assembly being secured is the adjacent surface of the base 26. In other embodiments, the surface 66 is adjacent a mating surface of an operator arm 34 being secured by the rivet 44.

The method of assembling parts of the operator assembly 20 with the rivet 44 is depicted in FIGS. 4-6. As is shown in FIG. 4, the assembly method first entails alignment of the rivet 44 with the operator assembly 20 parts, such as by insertion of the body 48 into the assembly parts, shown in the Figures as the base 26 and the gear 32. Alternatively, other parts of the assembly 20 may be assembled together, such as one or more of the operator arms 34 to the housing 24, or an operator arm 34 secured to the gear 32. Applying force between opposed dies, such as the head die 68, and an opposed die (not shown), from opposite directions toward the rivet body 48, portions of the rivet 44 are forced into deformation to trap the operator parts together. More specifically, a first die is moved toward the rivet body 48 in the direction of the force F1, and a second die (shown as 68 in FIG. 4) is moved toward the rivet body 48 in the direction of the force F2. As the second die 68 progresses on its forced path F2, a die protrusion 70 is inserted into the passageway 58 and toward the recess surface 60 of the rivet 44. Progressing further with movement of the opposed dies in opposing force path F1, F2, a generally conical or domed-shaped surface 72 of the rivet head die 68 engages with the outer surface 74 of the rivet head 50.

Because of the curved recessed configuration of the die 68, the outer area of the fingers make early contact with the die 68, as is shown in FIG. 4. The force against this mating region of the rivet head 50 and the cupped recessed surface 72 of the die results in sequential deformation of the rivet head 50 by the die 68, first deforming the outer regions 76 of the finger(s) 52, then deforming the inner regions 78 of the fingers 52. In this manner, the rivet head 50 secures the parts being fastened together by a smooth progressive sequence of deformation of the rivet head 50 along the smooth conical anvil surface 72 of the die 68. Thus, the rivet head 52 is deformed by the anvil surface 72 applying a progressive force in directions 79A, 79B that transects the central axis 46 of the rivet 44. More specifically, the domed die surface 72 acting on the flat outer surface 74 of the rivet head 50 results in a progressively migrating deformation force in direction 79A, 79B transverse to the central axis 46 of the rivet head 50. This method of deforming the rivet head 52 facilitates proper formation of the rivet 44 to secure parts together without binding. This rivet structure, formed with the conical die, assure proper fit and compression even though the thickness of the parts (e.g., gears and arms) may vary, and regardless of necessary variation to the length of the rivet body 48.

As the dies are forced together F1, F2, the rivet head 50 is fully deformed into the recess of the domed die surface 72 such that a contact surface 80 of the fingers 52 is pressed against the adjacent contact surface 82 of the parts of the assembly 20 being secured by the rivet 44. In the embodiment shown in the Figures (FIGS. 4-6), the rivet contact surface 80 is forced into contact with the adjacent surface 82 of the gear (FIG. 5). At the opposite end of the rivet 44, a deformable end portion 84 of the body 48 is deformed by a force that distorts the end 84, thus expanding the outer dimension of the end 84 to engage in locking arrangement against the housing base 26.

As is shown in FIG. 6, after the rivet 44 has been compressed between the dies and thereby secured in place, there exists an amount of slack or spacing 88 between the rivet head surface 80 and the adjacent surface 82. This slack 88 or spacing between the parts is the result of natural spring-back of the metal rivet head 50, and specifically the spring-back of the deformation of the metal rivet head fingers 52. This preferred amount of spring back and resulting slack space 88 is thereby achieved in a consistent manner even though the relative thicknesses of parts may vary between differing operator assembly types. In the embodiment shown in the Figures, the outer peripheral region of the fingers 52 includes a thickened portion 90 which has a thickness greater than the thickness of the adjacent area 92 of the rivet head 50. In the embodiment shown in the Figures (FIG. 5), the adjacent area 92 is so drastically reduced in thickness that an annular recess 94 is formed into the underside of the rivet head 50. The thickened region 90 provides a protruding body of the rivet head 50 for contact of the surface 80 with the adjacent surface 82 to thereby restrict the displacement and resulting deformation of the rivet head 50. This restriction of the deformation of the rivet head 50 provides structural limitation of the rivet compression when compressed by the conical die surface 72, thus assuring a loose fit between the working parts secured by the rivet without binding in firm frictional contact, such as the gear 32 and housing 26 shown in the Figures. This loose fit of the parts, such as to allow for a slight amount of space 88 to prevent locking engagement, is important for the required movement of the parts of the operator assembly 20.

Therefore, the structure resulting from this method of assembly provides a secure rivet in which the fingers 52 of the rivet head 50 are formed into a cup shape of the conical recess die 68, while the central region of the rivet head 50 is not substantially deformed. This method provides uniquely controlled deformation of the rivet head 50 in a controlled fashion, due to the combination of the conical die surface 72 and the central recess 56 engaged in the area of the die protrusion 70. In this manner, the assembly method of the present invention results in a unique rivet structure in which the fingers 52 are directed toward the parts of the assembly 20 being fastened, and the central region of the rivet head 50 is not substantially deformed and thus remains in spaced relationship from the parts of the assembly 20 being assembled.

While the specific embodiments have been illustrated and described, numerous modifications come to mind without significantly departing from the spirit of the invention, and the scope of protection is only limited by the scope of the accompanying Claims.

What is claimed is:

1. An operator for a window assembly having a window moveably connected to a window frame, the window operator comprising;
a body having a base configured for mounting to the window assembly, and a drive member exposed from said body, the drive member being operably connected to an operator arm having a first portion extending from the body and a second portion operably connected to said window;
the operator arm being connected to the drive member with at least one mating gear member, said gear member having a plurality of teeth arranged for mating with a screw arrangement of the drive member, and wherein the gear member is mounted to the base by a rivet, said rivet having an upper head with a terminal portion biased toward the operator arm and deformed in a generally conical shape by a force applied along a cupped die surface.

2. The operator assembly of claim 1, wherein;
the upper head has a thickened portion located at an outer peripheral region.

3. The assembly of claim 2, wherein;
the rivet head has a plurality of fingers extending radially outward and the thickened portion of the rivet head is formed as a ring of thickened material located at an outer region of the rivet head.

4. The assembly of claim 1, wherein;
the rivet head has a central region connected to the rivet body and an outer periphery of the rivet head is formed of a plurality of radially extending thickened petals, each petal located in a position generally aligned with and opposed petal, wherein the rivet head has a smooth outer surface formed on the cupped die surface.

5. A casement window assembly, comprising;
a window member and a frame assembly positioned for mating closure and pivotal opening of the window member relative the frame assembly by a closure assembly, the closure assembly having an operator with an exposed handle and a linkage assembly for transferring movement of the handle to mechanical manipulation of the window member between the open and closed positions;
said closure assembly having a base assembly with a base member secured to the frame assembly, wherein the base assembly includes a rivet fastener securing a portion of the linkage assembly, said rivet including a body portion and a rivet head, wherein the rivet body portion passes through an opening of the linkage assembly and the rivet head has a generally domed outer surface formed by compression of the rivet with a forming tool having a generally conical shaped die surface.

6. The casement window assembly of claim 5, wherein;
the rivet head has an outer peripheral region residing radially outward of said rivet body portion, and the rivet head has a thickened region at said outer peripheral region.

7. The assembly of claim 6, wherein;
the peripheral region of the rivet head has an interior surface facing a portion of the linkage assembly, and the interior surface of a portion of the thickened portion being located closer to said linkage assembly than adjacent portions of the rivet head.

8. The assembly of claim 6 wherein;
the thickened portion of the rivet head is formed as a ring of thickened material on the inner surface of the outer region of the rivet head and the domed outer surface is smooth in the thickened region.

9. The assembly of claim 5, wherein;
the rivet head has a central region connected to the rivet body and the outer periphery of the rivet head is formed of a plurality of radially extending fingers, wherein said domed outer surface of the rivet head is formed from a deformed flat rivet head surface compressed by the conical die.

10. A rivet fastener for securing a linkage member of a casement window operator, comprising;
a rivet body portion having a central axis and a first end formed of material suitable for compressive deformation and a second end having a rivet head;
the rivet head having a central region connected to the rivet body and an outer periphery region formed from a plurality of fingers extending outward of the central portion and with terminal ends residing radially outward of the central axis of the rivet body, said rivet head being configured to be secured to the linkage member with a deformed rivet head having a generally domed shape formed by compressive force applied between said first and second ends of the rivet wherein the force applied at the rivet head is made by a forming die having a smooth cupped recess configured to provide a rivet head deformed in to a smooth domed shape.

11. The rivet fastener of claim 10, wherein;
the peripheral region of the rivet head has an interior surface, wherein a portion of said interior surface extends outward in a direction parallel with said central axis of the rivet body.

12. The assembly of claim 11, wherein;
thickened portion of the rivet head is formed as a ring of material located at the outer region of the rivet head.

13. A method for securing a linkage member for a window operator for use in a casement window, comprising the steps of,
providing a rivet having a rivet body with a deformable first end and an opposed end having a rivet head, wherein the rivet head has generally flat outer surface and a central recess with a thickened region residing at a periphery radially outward of the central recess;
providing a linkage assembly having a first linkage member with a receiving portion configured for insertion of a portion of the rivet body, and a second linkage member having a receiving portion for insertion of a portion of the rivet body;
inserting the rivet body into the receiving portions of the first and second linkage members and placing an inner surface of the rivet head in contact with an adjacent surface of either the first or second linkage member;
compressing the rivet between two forming die surfaces, each forming surface located at an opposed end of the rivet body, wherein the die surface in contact with the rivet head has a smooth cup-shaped concave contact surface to form a smooth conical shape of the rivet head surface.

14. The method of claim 13, wherein, prior to the step of compressing the rivet, the method further comprising the steps of;
providing a rivet body having a shoulder configured for mating with a portion of the second linkage members, and inserting the rivet body into the first linkage member and the second linkage member, such that a surface of the second linkage member is in contact with the shoulder of the rivet.

15. The method of claim 13, further comprising the steps providing the rivet having the rivet head including a plurality of outwardly extending thickened fingers, and the step of compressing the rivet includes the steps of compressing the rivet between the two forming dies such that the thickened petals are compresses by an outer area of the conical die.

16. The method of claim 13, wherein the step of compressing the rivet includes applying opposing force along a central axis of the rivet, and wherein the force applied on the rivet head by the cup-shaped die surface deforms the rivet head in a progressive sequence of compression contact between the die and rivet head.

17. The method of claim 16, wherein the progressive sequence of contact between the die and the rivet head provides a deformation force on the rivet head in a direction that transects the central rivet axis.
